(19) United States
(12) Patent Application Publication
(10) Pub. No.: US 2018/0046773 A1
(43) Pub. Date: Feb. 15, 2018

(54) MEDICAL SYSTEM AND METHOD FOR PROVIDING MEDICAL PREDICTION

(71) Applicant: HTC Corporation, Taoyuan City (TW)

(72) Inventors: Kai-Fu TANG, TAOYUAN CITY (TW); Hao-Cheng KAO, TAOYUAN CITY (TW); Chun-Nan CHOU, TAOYUAN CITY (TW); Edward CHANG, TAOYUAN CITY (TW); Chih-Wei CHENG, TAOYUAN CITY (TW); Ting-Jung CHANG, TAOYUAN CITY (TW); Shan-Yi YU, TAOYUAN CITY (TW); Tsung-Hsiang LIU, TAOYUAN CITY (TW); Cheng-Lung SUNG, TAOYUAN CITY (TW); Chieh-Hsin YEH, TAOYUAN CITY (TW)

(21) Appl. No.: 15/674,538

(22) Filed: Aug. 11, 2017

Related U.S. Application Data
(60) Provisional application No. 62/373,966, filed on Aug. 11, 2016.
(60) Provisional application No. 62/505,135, filed on May 12, 2017.

(51) Int. Cl. G06F 19/00; G06N 99/00; G06N 5/04

(52) U.S. Cl. CPC G06F 19/345; G06N 5/04; G06N 99/005; G06F 19/3418; G06F 19/322

(57) ABSTRACT

A medical system includes an interaction interface and an analysis engine. The interaction interface is configured for receiving an initial symptom. The analysis engine is communicated with the interaction interface. The analysis engine includes a prediction module. The prediction module is configured for generating symptom inquiries to be displayed on the interaction interface according to a prediction model and the initial symptom. The interaction interface is configured for receiving responses corresponding to the symptom inquiries. The prediction module is configured to generate a result prediction according to the prediction model, the initial symptom and the responses.

### RELATED APPLICATIONS

This application claims priority to U.S. Provisional Application Ser. No. 62/373,966, filed Aug. 11, 2016, and U.S. Provisional Application Ser. No. 62/505,135, filed May 12, 2017, which are herein incorporated by reference.

### BACKGROUND

### Field of Invention

The disclosure relates to a medical system. More particularly, the disclosure relates to a computer-aided medical system to generate a medical prediction based on symptom inputs.

### Description of Related Art

Recently the concept of computer-aided medical system has emerged in order to facilitate self-diagnosis for patients. The computer-aided medical system may request patients to provide some information, and then attempts to diagnose the potential diseases based on the interactions with those patients. In some cases, the patients do not know how to describe their health conditions or the descriptions provided by the patients may not be understandable to the computer-aided medical system.

### SUMMARY

The disclosure provides a medical system. The medical system includes an interaction interface and an analysis engine. The interaction interface is configured for receiving an initial symptom. The analysis engine is communicated with the interaction interface. The analysis engine includes a prediction module. The prediction module is configured for generating symptom inquiries to be displayed on the interaction interface according to a prediction model and the initial symptom. The interaction interface is configured for receiving responses corresponding to the symptom inquiries. Finally, the prediction module is also configured to generate a result prediction according to the prediction model, the initial symptom and the responses.

In an embodiment, the prediction module is configured to generate a first symptom inquiry according to the prediction model and the initial symptom. The first symptom inquiry is displayed on the interaction interface. The interaction interface is configured to receive a first response corresponding to the first symptom inquiry. The prediction module is further configured to generate a second symptom inquiry according to the prediction model, the initial symptom and the first response. The second symptom inquiry is displayed on the interaction interface. The interaction interface is configured to receive a second response corresponding to the second symptom inquiry. The prediction module is configured to generate the result prediction according to the prediction model, the initial symptom, the first response and the second response.

In an embodiment, the medical system further includes a learning module configured for generating a prediction model according to the training data. The training data includes known medical records. The learning module utilizes the known medical records to train the prediction model.

In an embodiment, the training data further include a user feedback input collected by the interaction interface, a doctor diagnosis record received from an external server or a prediction logfile generated by the prediction module. The learning module further updates the prediction model according to the user feedback input, the doctor diagnosis record or the prediction logfile.

In an embodiment, the result prediction comprises at least one of a disease prediction and a medical department suggestion matching the disease prediction, wherein the disease prediction comprises a disease name or a list of disease names ranked by probability.

In an embodiment, after the result prediction is displayed on the interaction interface. The interaction interface is configured to receive a user command in response to the result prediction. The medical system is configured to send a medical registration request corresponding to the user command to an external server.

In an embodiment, the prediction model includes a first prediction model generated by the learning module according to a Bayesian inference algorithm. The first prediction model includes a probability relationship table. The probability relationship table records relative probabilities between different diseases and different symptoms.

In an embodiment, the prediction model includes a second prediction model generated by the learning module according to a decision tree algorithm. The second prediction model includes a plurality of decision trees constructed in advance according to the training data.

In an embodiment, the prediction model includes a third prediction model generated by the learning module according to a reinforcement learning algorithm. The third prediction model is trained according to the training data to maximize a reward signal. The reward signal is positive or negative according to the correctness of a training prediction made by the third prediction model. The correctness of the training prediction is verified according to a known medical record in the training data.

The disclosure further provides a method for providing a disease prediction which includes the following steps. An initial symptom is received. Symptom inquiries are generated according to the prediction model and the initial symptom. Responses are received corresponding to the symptom inquiries. A disease prediction is generated according to the prediction model, the initial symptom and the responses.

The disclosure further provides a non-transitory computer readable storage medium with a computer program to execute a method. The method include includes the following steps. An initial symptom is received. Symptom inquiries are generated according to a prediction model and the initial symptom. Responses are received corresponding to the symptom inquiries. A disease prediction is generated according to the prediction model, the initial symptom and the responses.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a medical system according to an embodiment of the disclosure.

FIG. 2 is a schematic diagram illustrating the medical system 100 in a demonstrational example.

FIG. 3 is a schematic diagram illustrating the analysis engine which includes the learning module establishing a first prediction model based on Bayesian Inference algorithm.

FIG. 4 is a schematic diagram illustrating the analysis engine which includes the learning module establishing a second prediction model based on decision tree algorithm.

FIG. 5 is a schematic diagram illustrating the decision trees in an embodiment.

FIG. 6 is a schematic diagram illustrating one decision tree among the decision trees in FIG. 5.

FIG. 7 is a schematic diagram illustrating the analysis engine which includes the learning module establishing a third prediction model based on reinforcement learning algorithm.

FIG. 8 is a flow chart diagram illustrating a method for providing a disease prediction.

FIG. 9 is a flow chart diagram illustrating a method for providing a disease prediction in a demonstrational example.

FIGS. 10A-10E illustrate embodiments of what the interaction interface 140 in FIG. 2 will show to guide the user to input the initial symptom and the responses.

FIG. 11A and FIG. 11B illustrate embodiments of what show on the interaction interface when the user have utilized the medical system before.

FIG. 12A and FIG. 12B illustrate embodiments of what show on the interaction interface when a clinical section which the user wants is full.

FIG. 13 shows a flow chart diagram illustrating how the medical system decides the initial symptom according to different types of user inputs.

FIG. 14 is a diagram illustrating the body map shown on the interaction interface in an embodiment.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

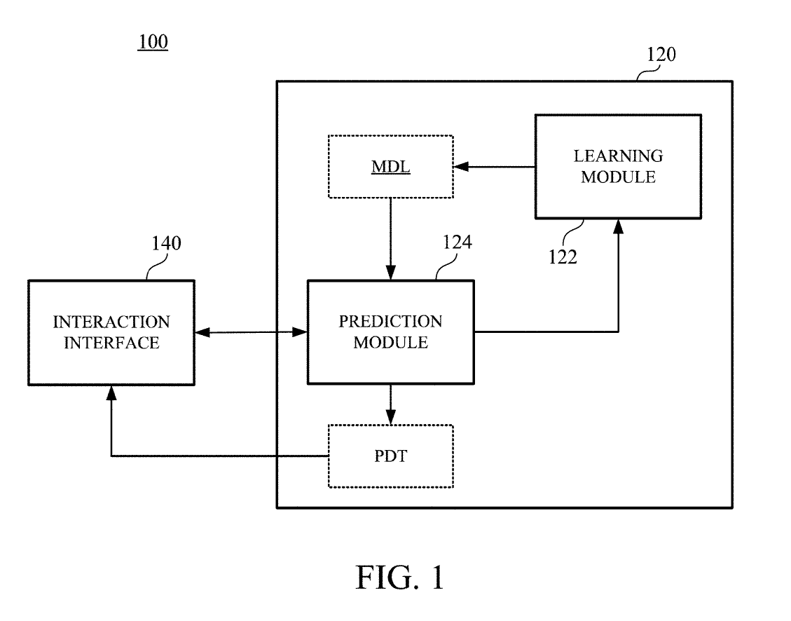

Reference is made to FIG. 1, which is a schematic diagram illustrating a medical system 100 according to an embodiment of the disclosure. The medical system 100 includes an analysis engine 120 and an interaction interface 140. The analysis engine 120 is communicated with the interaction interlace 140.

In some embodiments, the medical system 100 is established with a computer, a server or a processing center. The analysis engine 120 can be implemented by a processor, a central processing unit or a computation unit. The interaction interface 140 can include an output interface (e.g., a display panel for display information) and an input device (e.g., a touch panel, a keyboard, a microphone, a scanner or a flash memory reader) for user to type text commands, give voice commands or to upload some related data (e.g., images, medical records, or personal examination reports).

In some other embodiments, at least a part of the medical system 100 is established with a distribution system. For example, the analysis engine 120 is established by a cloud computing system. In this case, the interaction interlace 140 can be a smart phone, which is communicated with the analysis engine 120 by wireless. The output interface of the interaction interface 140 can be a display panel on the smart phone. The input device of the interaction interface 140 can be a touch panel, a keyboard and/or a microphone on the smart phone.

As shown in FIG. 1, the analysis engine 120 includes a learning module 122 and a prediction module 124. The learning module 122 is configured for generating a prediction model MDL according to training data.

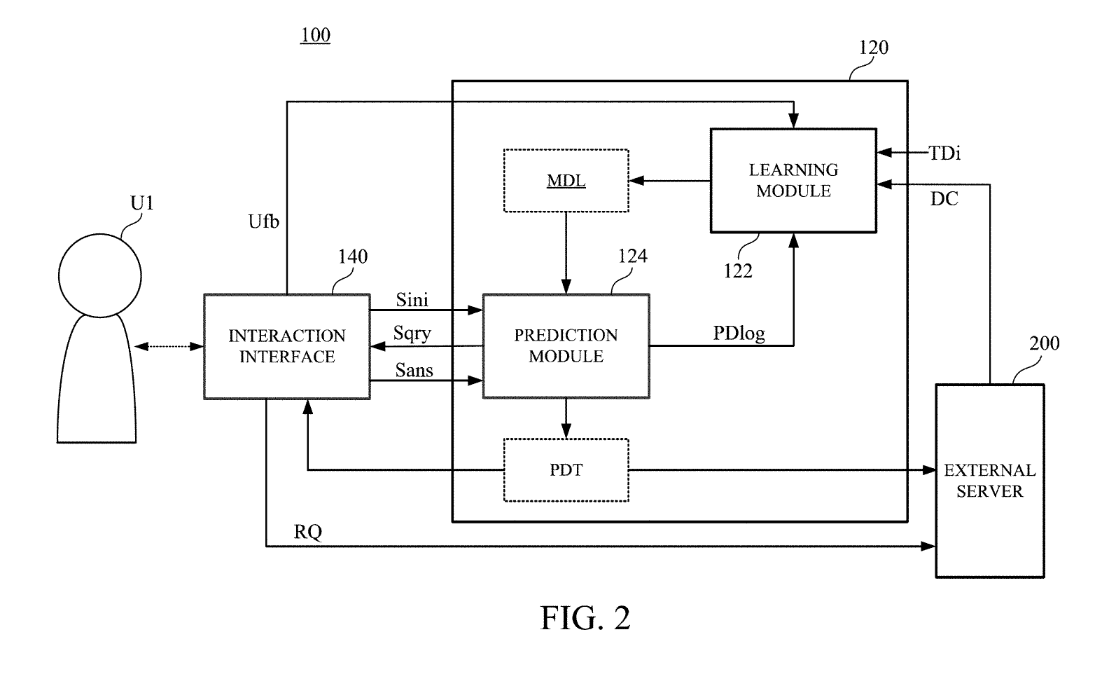

Reference is further made to FIG. 2, which is a schematic diagram illustrating the medical system 100 in a demonstrational example. In an embodiment, the training data includes known medical records TDi. The learning module utilizes the known medical records TDi to train the prediction model MDL. The learning module 122 is able to establish the prediction model MDL according to different algorithms. Based on the algorithm utilized by the learning module 122, the prediction model MDL might be different. The algorithms utilized by the learning module 122 and the prediction model MDL will be discussed later in the disclosure.

In one embodiment, the training data includes a probability relationship table according to statistics of the known medical records TDi. An example of the probability relationship table is shown in Table 1.

TABLE 1

| | | | Otitis | | | White blood |
|---|---|---|---|---|---|---|
| | Pneumonia | Anemia | media | COPD | . . . | cell disease |
| Coryza | 23% | | 30% | 31% | | |
| Difficulty | 43% | | | 39% | | |
| breathing | | | | | | |
| Vomiting | 41% | | 33% | | | 47% |
| Weakness | 29% | 28% | | | | 28% |
| Cough | 82% | | 71% | 83% | | 33% |
| Sore | 26% | | 41% | 42% | | |
| throat | | | | | | |
| . . . | | | | | | |
| Shortness | 69% | 26% | | 70% | | |
| Of breath | | | | | | |
| Fever | 75% | 61% | 76% | 49% | | 61% |

The values in Table 1 represent the percentages of patients who have the diseases on the top have the symptoms listed in the leftmost column. According to the probability relationship table shown in Table 1, 23 out of 100 Pneumonia patients have the symptom of coryza, and 43 out of 100 Pneumonia patients have the symptom of difficulty breathing. In this embodiment, the training data include a probability relationship between different symptoms and different diseases. In an example, the training data including the probability relationship table as shown in Table 1 can be obtained from data and statistics information from the Centers for Disease Control and Prevention (https://www.cdc.gov/datastatistics/index.html).

As shown in FIG. 2, the interaction interface 140 can be manipulated by a user U1. The user U1 can see the information displayed on the interaction interface 140 and enters his/her inputs on the interaction interface 120. In an embodiment, the interaction interface 140 will display a notification to ask the user U1 about his/her symptoms. The first symptom inputted by the user U1 will be regarded as an initial symptom Sini. The interaction interface 140 is configured for receiving the initial symptom Sini according to user's manipulation. The interaction interface 140 transmits the initial symptom Sini to the prediction module 124.

As shown in FIG. 2, the prediction module 124 is configured for generating symptom inquiries Sqry to be displayed on the interaction interface 140 according to the prediction model MDL and the initial symptom Sini. The symptom inquiries Sqry are displayed on the interaction interface 140 sequentially, and the user U1 can answer the symptom inquiries Sqry through the interaction interface 140. The interaction interface 140 is configured for receiving responses Sans corresponding to the symptom inquiries Sqry. The prediction module 124 is configured to generate a result prediction, such as at least one disease prediction PDT (e.g., a disease name or a list of disease names ranked by their probabilities) or/and at least one medical department suggestion matching the possible disease (reference is made to Table 2 as follows) according to the prediction model MDL, the initial symptom Sini and the responses Sans. Based on the prediction model MDL, the prediction module 124 will decide optimal questions (i.e., the symptom inquiries Sqry) to ask in response to the initial symptom Sini and all previous responses Sans (before the current question). The optimal questions are selected according to the prediction model MDL in order to increase efficiency (e.g., the result prediction can be decided faster or in fewer inquiries) and the correctness (e.g., the result prediction can be more accurate) of the result prediction.

TABLE 2

| Predict | Appointment department suggestions |
|---|---|
| Asthma | Chest Medicine, Rheumatology |
| COPD | Chest Medicine |
| Pneumonia | Chest Medicine |
| Acute sinusitis | Otolaryngology |
| Migraine | Neurology |
| Gallstone | Gastroenterology |
| Noninfectious gastroenteritis | Gastroenterology |
| Leukemia | Hematology & Oncology |
| Strep throat | Otolaryngology |

In an embodiment, the learning module 122 and the prediction module 124 can be implemented by a processor, a central processing unit, or a computation unit.

As shown in FIG. 2, a patient may provide symptom input through the interaction interface 140 to the prediction module 124. Based on the symptom input from the patient, the prediction module 124, referring to the prediction model MDL, is able to generate a disease result prediction.

In some embodiments, the patient may provide the initial symptom Sini (e.g., fever, headache, palpitation, hard to sleep). The prediction module 124 will generate a first symptom inquiry (e.g., including a question of one symptom or multiple questions of different symptoms) according to the initial symptom Sini. The first symptom inquiry is the first one of the symptom inquiries Sqry shown in FIG. 2. In some embodiments, the initial symptom Sini includes descriptions (degree, duration, feeling, frequency, etc.) of one symptom, and/or descriptions of multiple symptoms from the patient.

In some embodiments, the symptom inquiry Sqry can be at least one question to ask whether the patient experience another symptom (e.g., “do you cough?”) other than the initial symptom Sini. The patient responds to the first symptom inquiry through the interaction interface 140. The interaction interface 140 is configured to receive a first response from the user U1 corresponding to the first symptom inquiry. The interaction interface 140 will send the first response to the prediction module 124. The first response is the first one of the responses Sans shown in FIG. 2.

After the patient responds to the first symptom inquiry, the prediction module 124 will generate a second symptom inquiry (i.e., the second one of the symptom inquiries Sqry) according to the initial symptom Sini and also the first response.

Similarly, the interaction interface 140 is configured to receive a second response from the user U1 corresponding to the second symptom inquiry. The interaction interface 140 will send the second response (i.e., the second one of the responses Sans) to the prediction module 124. After the patient responds to the second symptom inquiry, the prediction module 124 will generate a third symptom inquiry according to all previous symptoms (the initial symptom Sini and the all previous responses Sans), and so on.

Each symptom inquiry is determined by the prediction module 124 according to the initial symptom Sini and all previous responses Sans.

After giving sequential symptom inquiries and receiving the responses from the patients, the prediction module 124 will generate the result prediction according to these symptoms (the initial symptom Sini and all the responses Sans). It is noticed that the medical system 100 in the embodiment will actively provide the symptom inquiries one by one to the user other than passively wait for the symptom inputs from the user. Therefore, the medical system 100 may provide an intuitive interface for self-diagnosis to the user.

In some embodiments, the result prediction will be made when a predetermined number of inquiries (e.g., 6 inquiries) has been asked, when a predetermined time limitation (e.g., 15 minutes) is reached, and/or a confidence level of the prediction by prediction module exceed a threshold level (e.g., 85%).

Besides the initial symptom(s) input, other information of the patient, such as a Demographic Information Input (e.g., gender, age of the patient), a Medical Record Input (e.g., blood pressure, SPO2, ECG, Platelet, etc.), a Psychological Information Input (e.g., emotion, mental status, etc.), and/or gene input (e.g., DNA, RNA, etc.), can be provided to the prediction module 124.

These personal information can be taken in consideration while the prediction module 124 selects the symptom inquiry or makes the prediction. For example, when the gender of the patient is male, the prediction will avoid “Cervical Cancer” or/and “Obstetrics and Gynecology Department” and the symptom inquiry will avoid “Menstruation Delay”. In some other embodiments, when the patient is adult, the prediction will avoid “Newborn jaundice” or/and “Pediatric Department” and the symptom inquiry will avoid “Infant feeding problem”.

The aforementioned embodiments are related to what disease or/and department the module should avoid predicting according to the personal information. However, the prediction module 124 and the analysis engine 120 are not limited thereto. In some other embodiments, the personal information is taken into consideration to adjust the weights or probabilities of different symptoms. The personal information may provide a hint or suggestion to increase/decrease the weight or probability of a specific type of symptoms and/or the probability of the predicted diseases and/or department. In these embodiments, the prediction module 124 and the analysis engine 120 will evaluate or select the symptom inquiry and make the result prediction according to the combination of the initial symptom, previously responses and/or these personal information together (e.g., the disease prediction PDT is determined according to a weighted consideration of a weight of 30% on the initial symptom, a weight of 40% on the previously responses and a weight of 30% on the personal information, or other equivalent weight distributions).

The prediction module 124 is utilized to help the patient and/or a doctor to estimate the health condition of the patient. The result prediction can be provided to the patient and/or the medical professionals. In an embodiment, the result prediction is displayed on the interaction interface 140, such that the user U1 can see the disease prediction or/and the medical department suggestion and decide to go to a hospital for further examinations and treatments. In another embodiment, the result prediction can also be transmitted to the external server 200, which can be a server of a hospital. The medical system 100 can generate a registration request to the external server 200 for making a medical appointment between the user U1 and the hospital. In addition, the result prediction, the initial symptom Sini and the responses Sans can be transmitted to the external server 200, such that the doctor in the hospital can evaluate the health condition of the user U1 faster.

In another embodiment, the training data utilized by the learning module 122 further include a user feedback input Ufb collected by the interaction interface 140. For example, after the result prediction is given by the medical system 100, the user can make a medical appointment to a hospital and the user can get a diagnosis and/or a treatment from a medical professional (e.g., doctor). Afterward, the interaction interface 140 will send a follow-up inquiry to check the correctness the result prediction (e.g., the follow-up inquiry can be sent to the user three days or one week after the result prediction). The follow-up inquiry may include questions about “how do you feel now”, “do you go to hospital after the last prediction”, “does the doctor agree with our prediction” and some other related questions. The interaction interface 140 will collect the answers from the user as the user feedback input Ufb. The user feedback input Ufb will be sent to the learning module 122 to refine the prediction model MDL. For example, when the user feedback input Ufb include an answer implying that the result prediction is not correct or the user does not feel well, the learning module 122 will update the result prediction to decrease the probability (or weight) of symptom inquiries or disease result related to the corresponding result prediction.

In another embodiment, the training data utilized by the learning module 122 further include a doctor diagnosis record DC received from an external server 200. For example, after the result prediction is given by the medical system 100, the user can make a medical appointment to a hospital and a medical profession (e.g., doctor) can make an official diagnosis. The official diagnosis is regarded as the doctor diagnosis record DC, which can be stored in the external server 200 (e.g., a server of a hospital, and the server of the hospital include a medical diagnosis database). Afterward, the medical system 100 will collect the doctor diagnosis record DC from the external server 200. The doctor diagnosis record DC will be sent to the learning module 122 to refine the prediction model MDL.

In another embodiment, the training data utilized by the learning module 122 further include a prediction logfile PDlog generated by the prediction module 124. For example, when the prediction module 124 gives the symptom inquiries to the user and one of the symptom inquiry is also has the same answer (e.g., the user always say yes in response to “do you feel tired”), the one symptom inquiry is not effective. The prediction logfile PDlog includes a history of the symptom inquiries and user's answers. The learning module 122 can refine the prediction model MDL according to the prediction logfile PDlog.

The learning module 122 further updates the prediction model MDL according to the user feedback input Ufb, the doctor diagnosis record DC or the prediction logfile PDlog.

The prediction module 124 may also generate a result prediction further included treatment recommendation, such as a therapy recommendation, a prescription recommendation and/or a medical equipment recommendation, to the medical professionals such as doctors, therapists and/or pharmacists. Therefore, the medical professionals are able to perform treatment(s) to the patient according to the treatment recommendation along with their own judgments. The aforementioned treatment(s) includes prescribed medication (e.g., antibiotic, medicine), prescribed medical device (e.g., X-ray examination, nuclear magnetic resonance imaging examination), surgeries, etc.

After the disease prediction PDT or the medical department suggestion is displayed on the interaction interface 140, the interaction interface 140 is configured to receive a user command in response to the disease prediction PDT or the medical department suggestion. The medical system 100 is configured to send a medical registration request RQ corresponding to the user command to the external server 200.

The learning module 122 is able to collect activity logs (e.g., the initial symptom(s), related information of the patient, a history of the symptom inquiries and responses to the inquiries) from the prediction module 124, the diagnosis results and/or the treatment results from medical departments (e.g., hospital, clinics, or public medical records). The learning module 122 will gather/process the collect information and store the processed results, so as to update parameters/variables for refining the prediction model MDL utilized by the prediction module 124. In some embodiments, the collected diagnosis results and/or the treatment results are utilized to update the prediction model MDL.

In one embodiment, the prediction module 124 in FIG. 1 and FIG. 2 is configured to ask proper inquiry questions (which can provide more information and make the prediction. There are different embodiments to generate the prediction model MDL by the learning module 122. For example, the inquiry selection (how to decide the symptom inquiries Sqry) and the disease prediction PDT of the prediction module 124 can be realized by the prediction model MDL established by Bayesian inference, decision tree, reinforcement learning, association rule mining, or random forest.

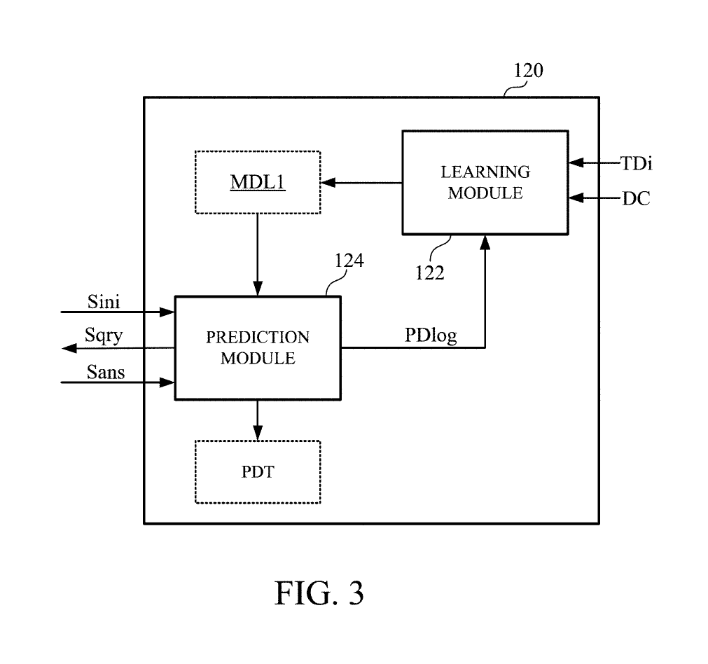

Reference is made to FIG. 3. FIG. 3 is a schematic diagram illustrating the analysis engine 120 which includes the learning module 122 establishing a first prediction model MDL1 based on the Bayesian inference algorithm. The first prediction model MDL1 includes the probability relationship table as shown in Table 1 and some score lookup tables generated from the probability relationship table based on an impurity function.

In the Bayesian inference algorithm, the probability relationship table (as shown in Table 1) between different diseases and different symptoms is utilized to determine how to select the next inquiry.

When the prediction module 124 based on the Bayesian inference algorithm selects the next inquiry, the prediction module 124 will consider the initial symptom Sini and previously response Sans and the probability relationship table as shown in Table 1.

When the initial symptom is given, the scores for each possible symptom can be derived from the probability relationship table, i.e., Table 1, according to an impurity function. Table 3 demonstrates an example of one score lookup table with 7 symptoms when the initial symptom is “cough”.

TABLE 3

| Symptoms | Scores |
|---|---|
| Fever | 0.0230163490254 |
| Shortness of breath | 0.129712728793 |
| Weakness | 0.153031402345 |
| Vomiting | 0.0602847857822 |
| Coryza | 0.027423922577 |
| Difficulty breathing | 0.108225397961 |
| Sore throat | 0.0308914664897 |

In Table 3, the scores of these symptoms can be derived from an impurity function (e.g., Gini impurity function or other equivalent impurity function) according to the probability relationship table, i.e., Table 1. An impurity function is a mapping from a probability distribution P={pi|1<=i<=N, sum(pi)=1, pi>=0} to a non-negative real value which satisfies the following constraints (a), (b), (c) and (d):

(a) the function achieves minimum values on P if there exists i, pi=1;

(b) the function achieves a maximum value on P if for all i, pi=1/N;

(c) the function is symmetric with respect to the components pi; and

(d) the function is smooth, i.e. differentiable everywhere.

The above constraints implies that the value of the function will be smaller if the probabilities are denser or higher. In order to get a certain prediction, the prediction module tends to pick the inquiry that leads to smallest impurity function value after the inquiry is answered.

To achieve this we calculate a score for each possible choice of inquiry. For each candidate, the score is determined by:

Score=“impurity function value before this inquiry”−“expected impurity function value after this inquiry”.

The score can be interpreted as the “gain” of impurity function value after each inquiry. Therefore, the prediction engine tends to pick the one with maximum score (if the score is positive).

According to the scores given in Table 3, when the initial symptom is “cough”, the prediction module 124 based on the Bayesian inference algorithm will select “weakness” as the next symptom to inquire. This selection leads to the consequence that if the patient's response to “weakness” is positive, the Bayesian inference algorithm could distinguish Pneumonia from Otitis media and COPD.

When the initial symptom (and/or the previous responses) is different, the scores for each candidate symptom will be different accordingly. There is an example of another score lookup table when the initial symptom provided is “Weakness”. In this case, the scores for each candidate symptom are shown as Table 4.

TABLE 4

| Symptoms | Scores |
|---|---|
| Fever | 0.00719259382666 |
| Shortness of breath | 0.15781292704 |
| Vomiting | 0.0941773884822 |
| Coryza | 0.263048073813 |
| Difficulty breathing | 0.309321471156 |
| Cough | 0.170104322494 |
| Sore throat | 0.26074568436 |

According to the scores above in Table 4, when the initial symptom is “Weakness”, the prediction module 124 based on the Bayesian inference algorithm will pick “Difficulty breathing” as the next symptom to inquire. Consequently, if the patient's response is positive then the Bayesian engine could distinguish Pneumonia from Anemia and White blood cell disease.

There are many selection criteria can be utilized in the Bayesian inference algorithm. For example, impurity based selection criteria (information gain, Gini gain), normalize based selection criteria (gain ratio, distance measure), binary metric selection criteria (towing, orthogonality, Kolmogorov-Smirnov), continuous attribute selection criteria (variance reduction) and other selection criteria (permutation statistic, mean posterior improvement, hypergeometric distribution) are possible ways to implement the selection criteria based on the Bayesian inference algorithm.

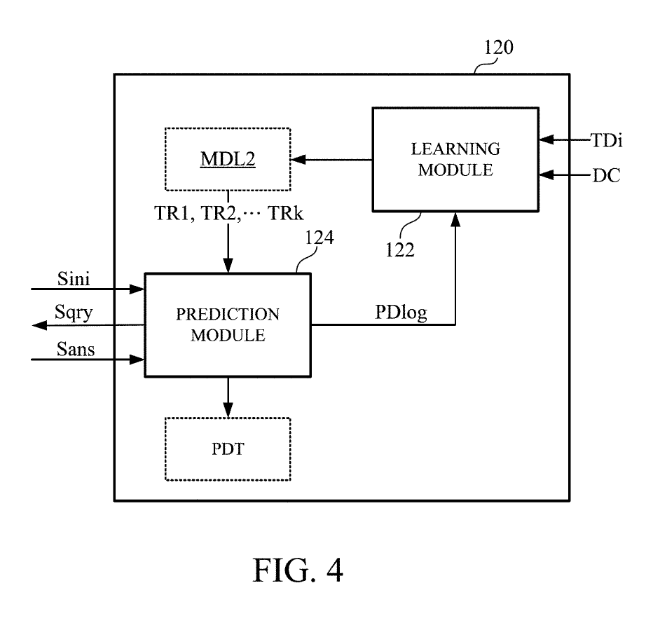

Reference is made to FIG. 4, which is a schematic diagram illustrating the analysis engine 120 which includes the learning module 122 establishing a second prediction model MDL2 based on the decision tree algorithm. In this algorithm, multiple trees are constructed in advance according to the training data. In the embodiment, the training data utilized by the decision tree algorithm may include the probability relationship table according to statistics of the known medical records TDi as shown in Table 1. The known medical records TDi can be obtained from data and statistics information from the Centers for Disease Control and Prevention (https://www.cdc.gov/). In some embodiments, the training data utilized by the decision tree algorithm may further include the user feedback input Ufb, the doctor diagnosis record DC or the prediction logfile PDlog to update the prediction model MDL, and it is discussed in the aforementioned embodiments.

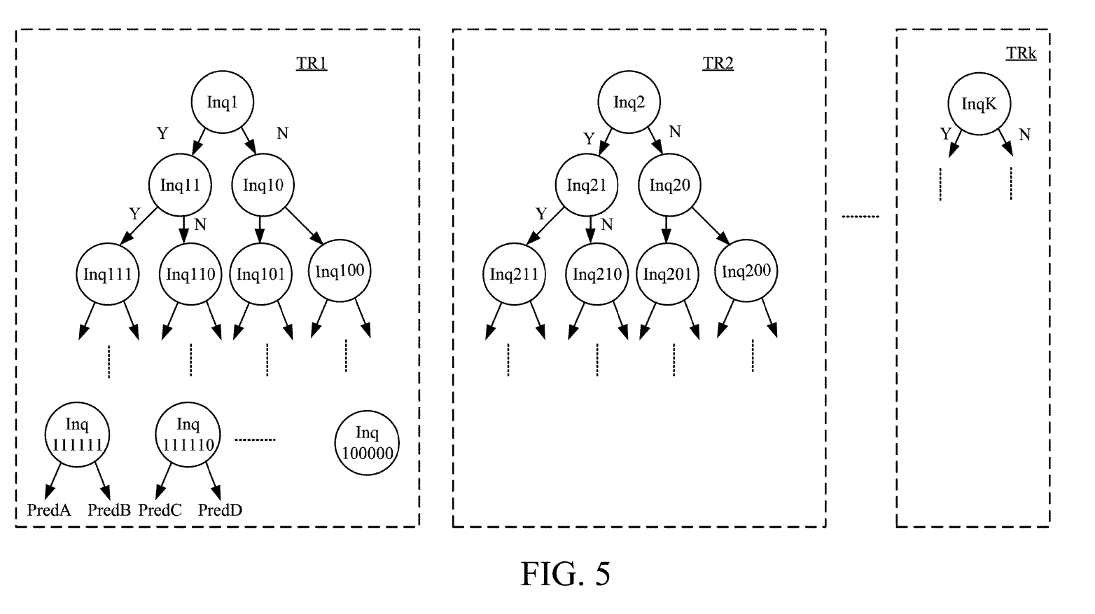

When the initial symptom is received, the prediction module 124 select one decision tree from the constructed decision trees. Reference is further made to FIG. 5, which is a schematic diagram illustrating the decision trees TR1-TRk in an embodiment.

As shown in FIG. 5, the decision trees TR1-TRk are binary trees (and/or partial trees). Each non-leaf node in the decision trees TR1-TRk is a symptom inquiry. When the patient responds (Yes or No) to a symptom inquiry, the prediction module will go to a corresponding node (the next inquiry) in the next level according to the answer. After sequential inquiries are answered, the decision trees TR1-TRk will go to a corresponding prediction (PredA, PredB, PredC, PredD . . . ). The decision trees TR1-TRk is selected according the initial symptom Sini provided by the user U1. When the user U1 provides different initial symptom Sini, the prediction module 124 will utilized different decision trees TR1-TRk to decide the following symptom inquiries Sqry and the result prediction, which the result prediction may include the disease prediction PDT (e.g., a disease name or a list of disease names ranked by their probabilities), a medical department suggestion matching the disease prediction PDT and/or a treatment recommendation.

Table 5 shows embodiments of different initial symptoms and different inquiry answers will lead to different predictions in different decision trees.

TABLE 5

| Init. | | | | | | | |
|---|---|---|---|---|---|---|---|
| Symptom | Step 1 | Step 2 | Step 3 | Step 4 | Step 5 | Step 6 | Predict |
| Wheezing | Arm | Allergic | Insomnia | Hurts to | Cough | Vomiting | Asthma |
| | weakness | reaction | (No) | breath | (Yes) | (No) | Sarcoidosis |
| | (No) | (No) | | (No) | | | Poisoning due |
| | | | | | | | to gas |
| Coughing | Palpitations | Hemoptysis | Wheezing | Difficulty in | Cough | Lump or mass | Foreign body |
| up sputum | (No) | (No) | (No) | swallowing | (Yes) | of breast | in the nose |
| | | | | (No) | | (No) | Myasthenia |
| | | | | | | | Gravis |
| | | | | | | | Myelodyspalastic |
| | | | | | | | syndrome |
| Nausea | Groin pain | Dizziness | Weight gain | Fever | Upper | Headache | Gallbladder |
| | (No) | (No) | (No) | (No) | abdominal | (No) | cancer |
| | | | | | pain | | Diabetic |
| | | | | | (No) | | ketoacidosis |
| | | | | | | | Gastroparesis |
| Fever | Suprapublic | Skin rash | Nosebleed | Eye redness | Sore throat | Diarrhea | Typhoid fever |
| | pain | (No) | (No) | (No) | (No) | (No) | Meningitis |
| | (No) | | | | | | Malaria |
| Difficulty | Hoarse voice | Neck pain | Leg | Loss of | Muscle | Skin lesion | Developmental |
| speaking | (No) | (No) | weakness | sensation | Cramp | (No) | disability |
| | | | (No) | (No) | (No) | | Spinocerebellar |
| | | | | | | | ataxia |
| | | | | | | | Amyotrophic |
| | | | | | | | lateral |
| | | | | | | | sclerosis |
| | | | | | | | (ALS) |
| Facial pain | Toothache | Excessive | Focal | Knee swelling | Ear pain | Fever | Fracture of |
| | (No) | urination at | weakness | (No) | (No) | (No) | the jaw |
| | | night | (No) | | | | Trigeminal |
| | | (No) | | | | | neuralgia |
| | | | | | | | Open wound |
| | | | | | | | of the cheek |

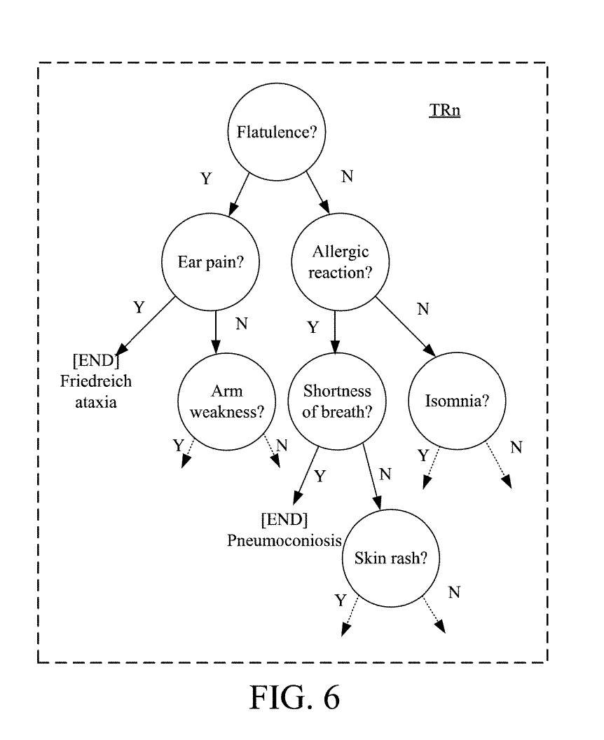

FIG. 5 shows embodiments of the decision trees TR1-TRk. However, each of the decision trees TR1-TRk may not include equal numbers of inquiry in each of the branches. The inquiring process may stop when the information is enough to give a reliable prediction. Reference is also made to FIG. 6, which is a schematic diagram illustrating one decision tree TRn among the decision trees TR1-TRk.

As shown in FIG. 6, the decision TRn will go to different inquiry symptom based on the previous answer(s) from the user U1 and also the depth of each branch might not be equal.

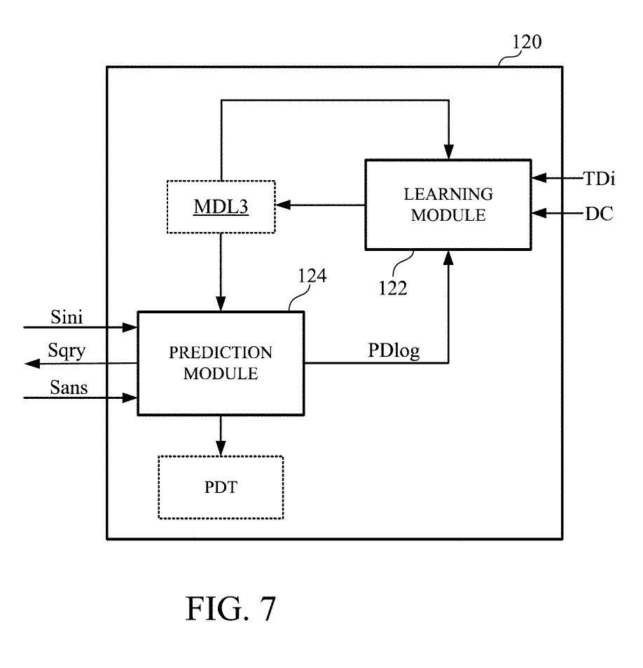

Reference is made to FIG. 7. FIG. 7 is a schematic diagram illustrating the analysis engine 120 which includes the learning module 122 establishing a third prediction model MDL3 based on reinforcement learning algorithm. The third prediction model MDL3 is trained according to the training data to maximize a reward signal. The reward signal is increased or decreased according to a correctness of a training prediction made by the third prediction model MDL3. The correctness of the training prediction is verified according to a known medical record in the training data. The third prediction model MDL3 is also regarded as an input to the learning module 122. The learning module 122 will repeatedly train the third prediction model MDL3 according to the variance of the reward signal in response to that the training prediction is correct or not.

The reinforcement learning algorithm utilizes training data set with known disease diagnosis(s) and known symptom(s) to train the third prediction model MDL3. In the embodiment, the training data utilized by the reinforcement learning algorithm may include the probability relationship table according to statistics of the known medical records TDi as shown in Table 1. The known medical records TDi can be obtained from data and statistics information from the Centers for Disease Control and Prevention (https://www.cdc.gov/). In some embodiments, the training data utilized by the decision tree algorithm may further include the user feedback input Ufb, the doctor diagnosis record DC or the prediction logfile PDlog to update the prediction model MDL, and it is discussed in the aforementioned embodiments. The reinforcement learning model is trained by performing a simulation of inputting the initial symptom(s) input and patient's responses to the symptom(s) inquiries, and the reinforcement learning model will make a result prediction afterward. The learning module 122 uses the known disease diagnosis to verify the predicted disease. If it is correct, reinforcement learning algorithm increases a potential reward of the asked inquiries in the simulation. If it is not correct, a potential reward of the asked inquiries is remained the same or decreased.

When the third prediction model MDL3 trained with the reinforcement learning algorithm selects the next inquiry, the third prediction model MDL3 tends to choose an optimal inquiry with the highest potential reward, so as to shorten the inquiry duration and elevate the preciseness of the prediction. Further details of the third prediction model MDL3 trained with the reinforcement learning algorithm are disclosed in the following paragraphs.

The third prediction model MDL3 trained with the reinforcement learning algorithm considers the diagnosis process as a sequential decision problem of an agent that interacts with a patient. There are a set of possible diseases and a set of possible symptoms. At each time step, the agent inquires a certain symptom of the patient (e.g., the user U1). The patient then replies with a true or false answer to the agent indicating whether the patient suffers from the symptom. In the meantime, the agent can integrate user responses over time steps to revise subsequent questions. At the end of the process, the agent receives a scalar reward if the agent can correctly predict the disease, and the goal of the agent is to maximize the reward. In other words, the goal is to correctly predict the patient disease by the end of the diagnosis process.

Based on the correctness of the prediction, the agent receives a reward signal (i.e. if the prediction is correct, the reward signal=1; otherwise the reward signal=0). The goal of training is to maximize the reward signal. On the other hand, reinforcement learning model use π(sₜ|h_{1:t-1},θ) to denote the policy function, where parameter θ represents the set of parameters, sₜ is one of possible symptoms, “t” is the time step, and h_{1:t-1} is the sequence of interaction history from time 1 to t−1. The parameter θ is learned to maximize the reward that the agent expects when the agent interacts with the patient.

The third prediction model MDL3 trained with the reinforcement learning algorithm is described as that effectively combines the representation learning of medical concepts and policies in an end-to-end manner. Due to the nature of sequential decision problems, the third prediction model MDL3 trained with the reinforcement learning algorithm adopts a recurrent neural network (RNN) as a core ingredient of the agent. At each time step, the recurrent neural network accepts patient's response into the network, integrates information over time in the long short-term memory (LSTM) units, and chooses a symptom to inquire the patient in the next time step. Last, the recurrent neural network predicts the patient disease indicating the completion of the diagnosis process.

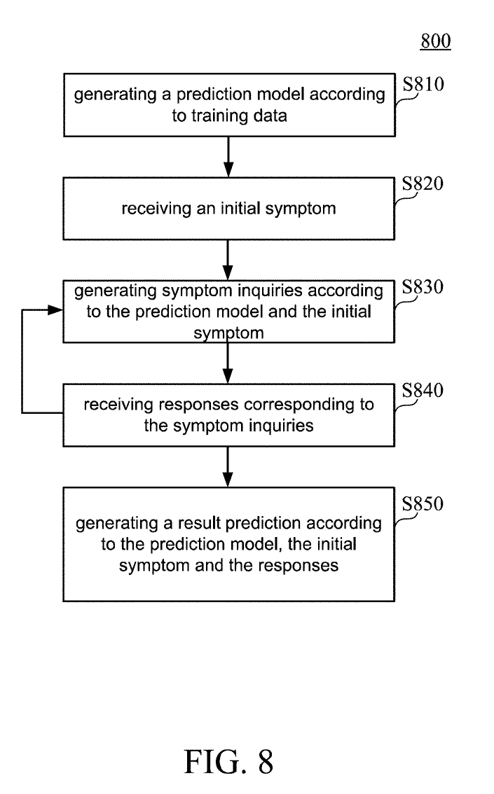

Reference is further made to FIG. 8, which is a flow chart diagram illustrating a method 800 for providing a result prediction. The method 800 for providing the result prediction is suitable to be utilized on the medical system 100 in the aforementioned embodiments as shown in FIG. 1 and FIG. 2. The method 800 for providing a result prediction includes the following steps. As shown in FIG. 2 and FIG. 8, step S810 is performed by the learning module 122 to generate a prediction model MDL according to the training data. Step S820 is performed by the interaction interface 140 to receive an initial symptom Sini. Step S830 is performed by the prediction module 124 to generate a series of symptom inquiries Sqry according to the prediction model MDL and the initial symptom Sini. Step S840 is performed by the interaction interface 140 to receive a series of responses Sans corresponding to the symptom inquiries Sqry. Step S850 is performed by prediction module 124 to generate a result prediction is generated according to the prediction model MDL, the initial symptom Sini and the responses Sans. It is noticed that the step S830 and the step S840 are executed in turn and iteratively. The series of symptom inquiries Sqry in the step S830 are not generated at once.

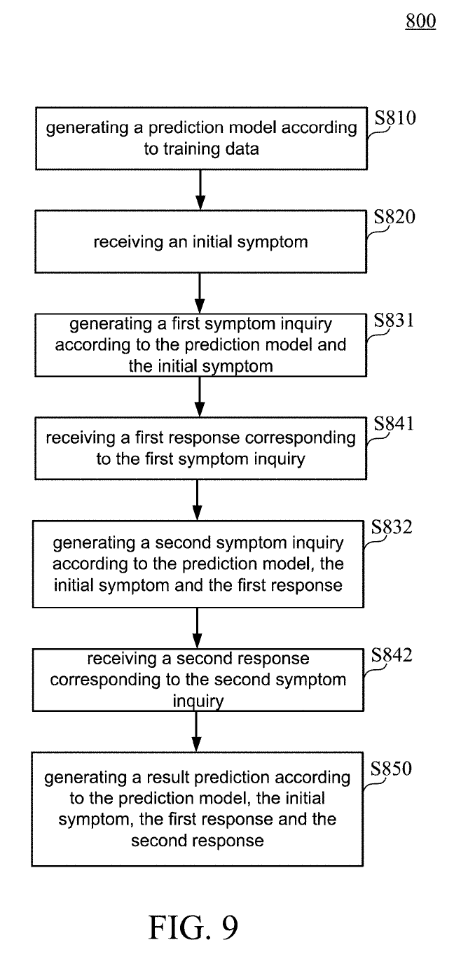

Reference is further made to FIG. 9, which is a flow chart diagram illustrating a method 800 for providing a result prediction in a demonstrational example. As shown in FIG. 2 and FIG. 9, step S810 is performed by the learning module 122 to generate a prediction model MDL according to the training data. Step S820 is performed by the interaction interface 140 to receive an initial symptom Sini. Step S831 is performed by the prediction module 124 to generate a first symptom inquiry according to the prediction model MDL and the initial symptom Sini. Step S841 is performed by the interaction interface 140 to receive a first response corresponding to the first symptom inquiry. Step S832 is performed by the prediction module 124 to generate a second symptom inquiry according to the prediction model MDL, the initial symptom Sini and the first response. Step S842 is performed by the interaction interface 140 to receive a second response corresponding to the second symptom inquiry. Step S850 is performed by prediction module 124 to generate a result prediction is generated at least according to the prediction model MDL, the initial symptom Sini, the first response and the second response.

It is noticed that the step S830 and the step S840 in FIG. 8 are executed in turn and iteratively as the steps S831, S841, S832 and S842 in FIG. 9. The series of symptom inquiries Sqry in the step S830 in FIG. 8 are not generated at once. As the embodiment shown in FIG. 9, the first one of the symptom inquiries Sqry is generated in the step S831. Then, the first one of the series of responses Sans is received in the step S841. Then, the second one of the symptom inquiries Sqry is generated in the step S832. Afterward, the second one of the series of responses Sans is received in the step S842.

In an embodiment, the step S830 and the step S840 in FIG. 8 are executed in turn and iteratively until the method 800 collects enough information for providing the result prediction.

It should be noted that, details of the method operation described above can be ascertained with reference to the embodiments described above, and a description in this regard will not be repeated herein.

As mentioned above, the computer-aided diagnosis engine requires the user to input an initial symptom, and the computer-aided diagnosis engine will generate proper inquiry questions according to the initial symptom (and the user's answers to previous inquiries). It is important to encourage the user to input a clear description of the initial symptom Sini.

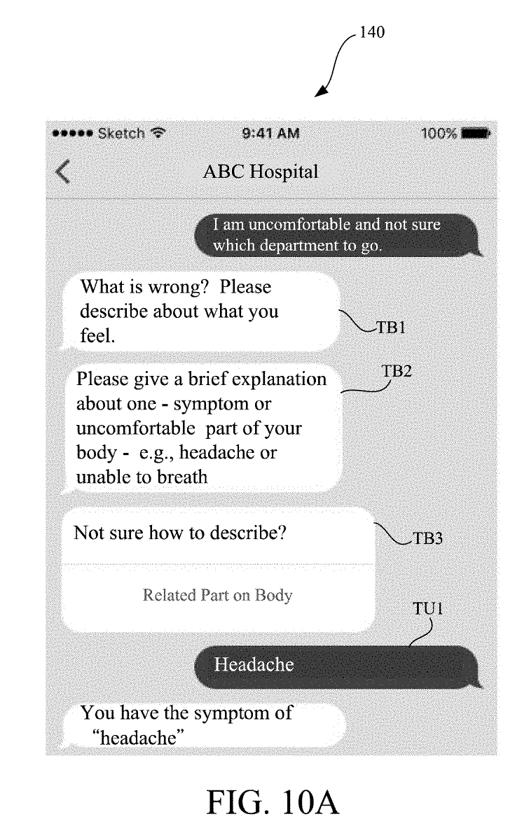

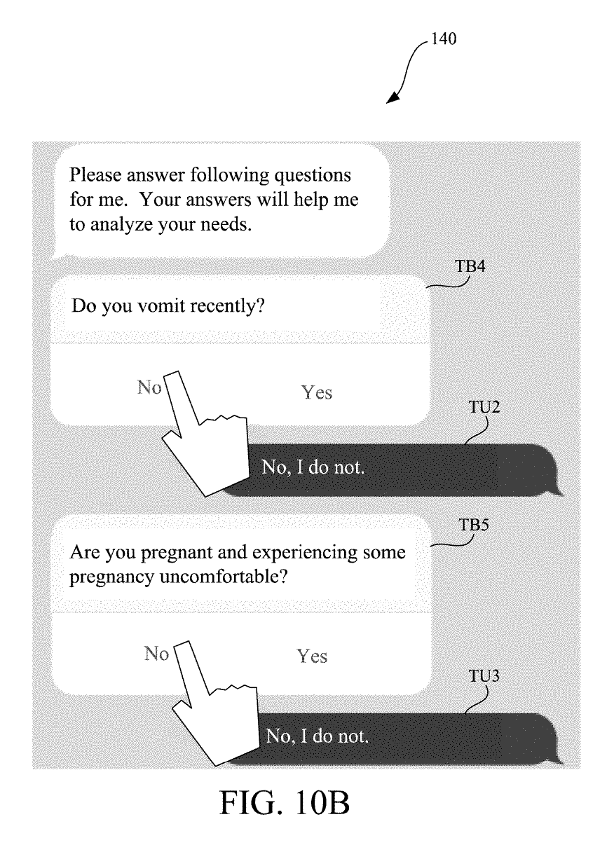

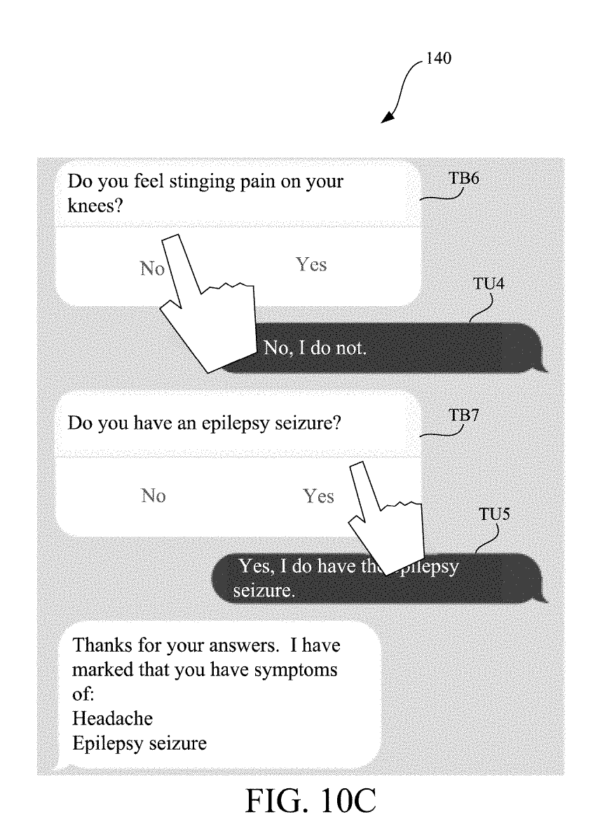

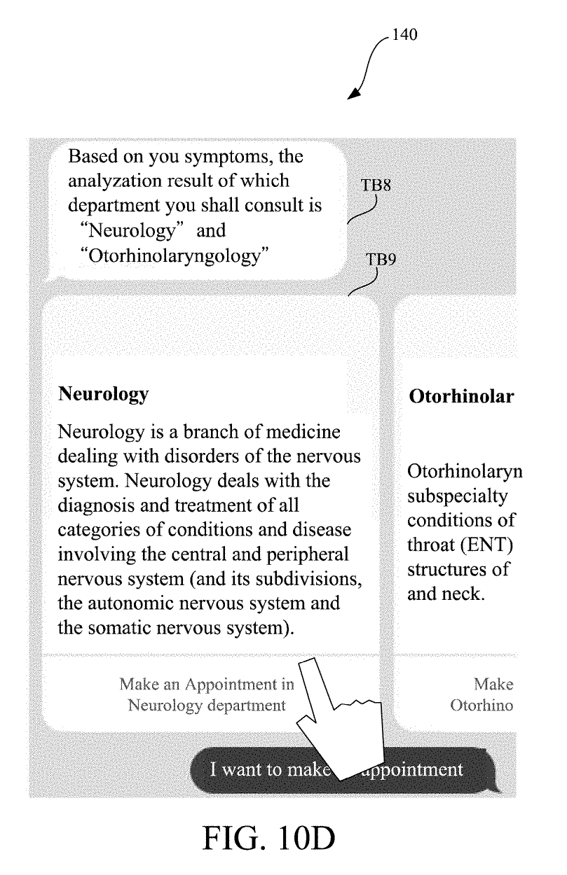

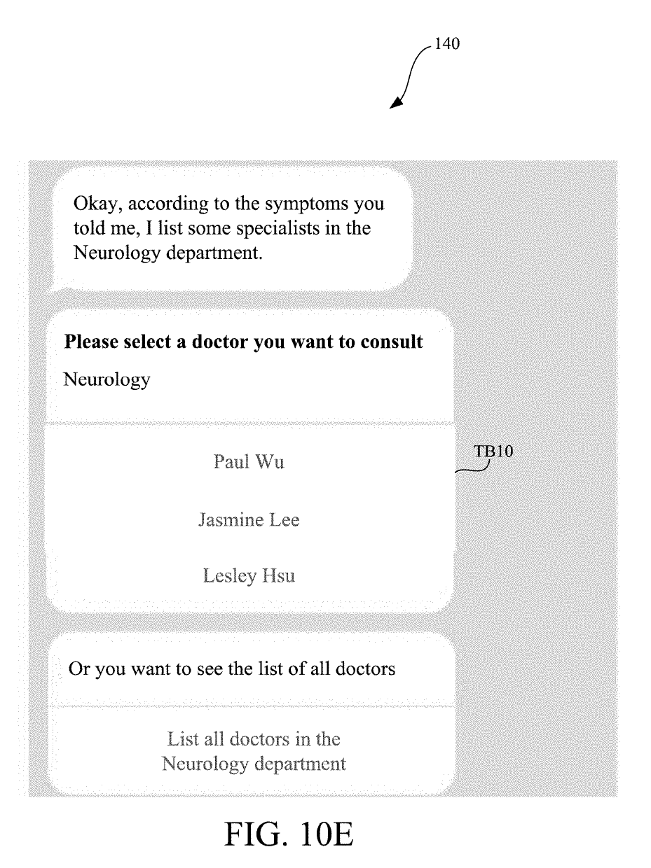

Reference is further made to FIG. 10A to FIG. 10E, which illustrate embodiments of what the interaction interface 140 in FIG. 2 will show to guide the user U1 to input the initial symptom Sini and the responses Sans made by clicking “Yes” or “No” bottom corresponding to the symptom inquiries (e.g., system messages TB4-TB7). In another embodiment, the symptom inquiries may be messages that display “Please input your symptom”, and the responses are disease names input by the user U1 via a text replay, a voice command or any equivalent input manner.

As shown in FIG. 10A, the medical system ask the user to enter his/her main symptom as system messages TB1-TB3 shown in FIG. 10A. In this case, the user can clearly describe his/her symptom by answering “Headache” as shown in the input message TU1. Therefore, the medical system repeats the user's answer. Then, the medical system can generate a series of inquiry questions (as the system messages) to predict the disease on the user as shown in FIG. 10B and FIG. 10C. As shown in FIG. 10B and FIG. 10C, the system messages ask simply yes/no questions (as system messages TB4-TB5 shown in FIG. 10B and system messages TB6-TB7 shown in FIG. 10C) to determine whether the user has other symptoms related to the initial symptom. The user can reply to the system messages (as input messages TU2-TU5) by pressing the yes/no button, typing text input or answering via voice commands, so as to provide more information.

In an embodiment, the inquiry questions generated by the medical system will consider personal information of the user/patient. The personal information can include gender, age, a medical record (e.g., blood pressure, SPO2, ECG, Platelet, etc.), psychological information (e.g., emotion, mental status, etc.) and/or gene (e.g., DNA, RNA, etc.) of the patient. The personal information can be collected by the medical system. For example, when the personal information indicates the person is a male, the medical system will not bring up the inquiry question about “are you pregnant and experiencing some pregnancy uncomfortable”. In other words, when the personal information indicates the gender of the patient is female, the symptom inquiry will avoid “Delayed Ejaculation”. In some other embodiments, when the patient is adult, the symptom inquiry will avoid “Infant feeding problem”. When the patient is an infant, the symptom inquiry will avoid “Premature menopause”. Similarly, the prediction generated by the medical system will also consider personal information of the user/patient.

As shown in FIG. 10D, the medical system will generate a prediction in a system message TB8 about user's disease and the medical system will show a system message TB9 to suggest a proper department to handle the disease. In this embodiment, the prediction may suggest that the user has the epilepsy. The medical system will suggest consulting the Neurology department. If the user accepts to make the appointment in the Neurology department, the medical system will show a system message TB10 to suggest a list of doctor who is specialized in handling the epilepsy among all doctors in the Neurology department. However, the user can still choose any doctor he/she wants to assign through the list of all doctors. When the user accepts to make the appointment, the medical system 100 will make an appointment registration. The analysis result in FIG. 10D and FIG. 10E is related to one department. However, in another embodiment, the analysis result may lead to two or more departments. In this case, the user can choose from the suggest departments first, and then choose the candidate doctors in the corresponding department afterward. For example, the disease is highly related to the Neurology department, and is also related to the Otorhinolaryngology department. The system message TB9 in FIG. 10D may include a slide bar with the Neurology department ranked at the first order and the Otorhinolaryngology department ranked at the second order.

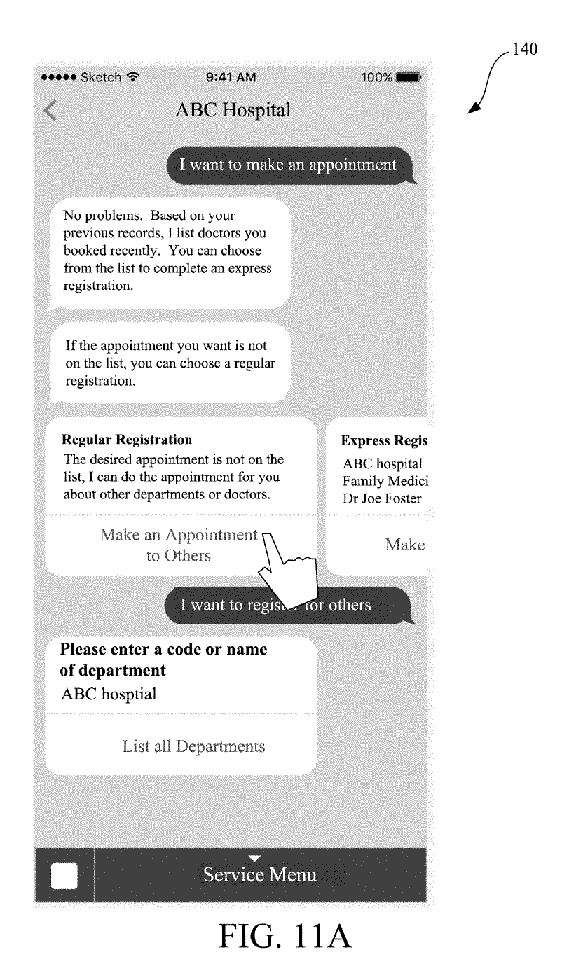

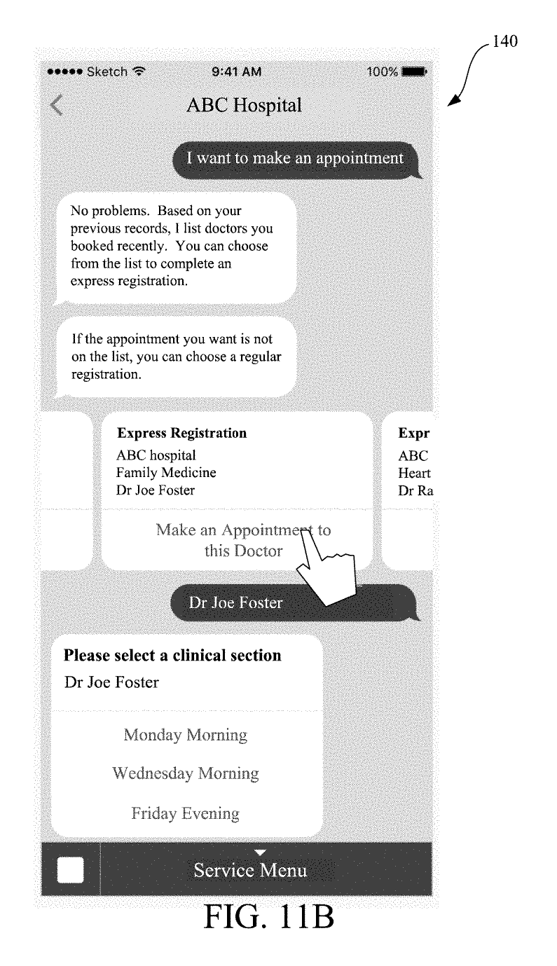

Reference is further made to FIG. 11A and FIG. 11B, which illustrate embodiments of what show on the interaction interface 140 when the user have utilized the medical system before. As shown in FIG. 11A, if the user has already utilized the medical system to make an appointment before and want to make another appointment, the interaction system may provide options including regular registration and express registration. The list of option(s) in the express registration is established according to user's history. If the user wants to make an appointment to different departments or different doctors (as shown in FIG. 11A), the user can choose the regular registration and enters corresponding procedures. If the user wants to make an appointment to the doctor who have been visited by the user, the user can slide to list to the right and choose the express registration, the interaction system will bring up his record and provide a shortcut to make the appointment to the doctor in the previous appointment as shown in FIG. 11B. The express registration may provide multiple options according to the user's history. As shown in FIG. 11B, if the user have visited heart department according to the user's history, the interaction interface 140 may also show the option for express registration related to another doctor in the heart department.

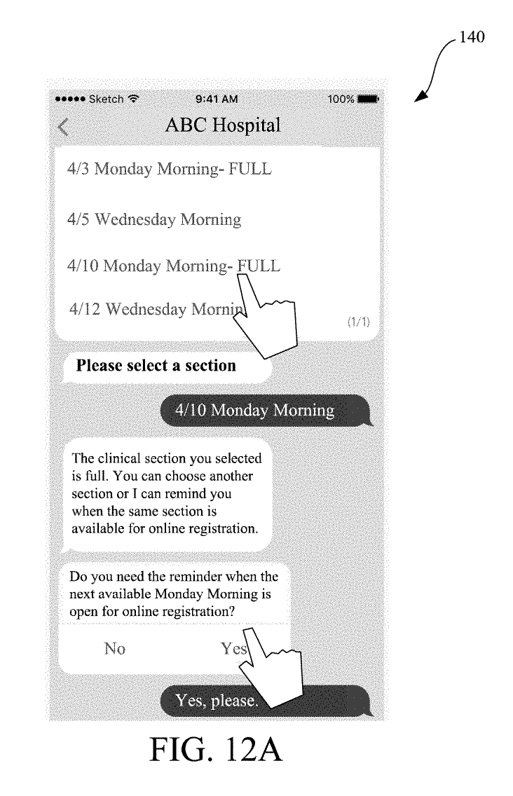

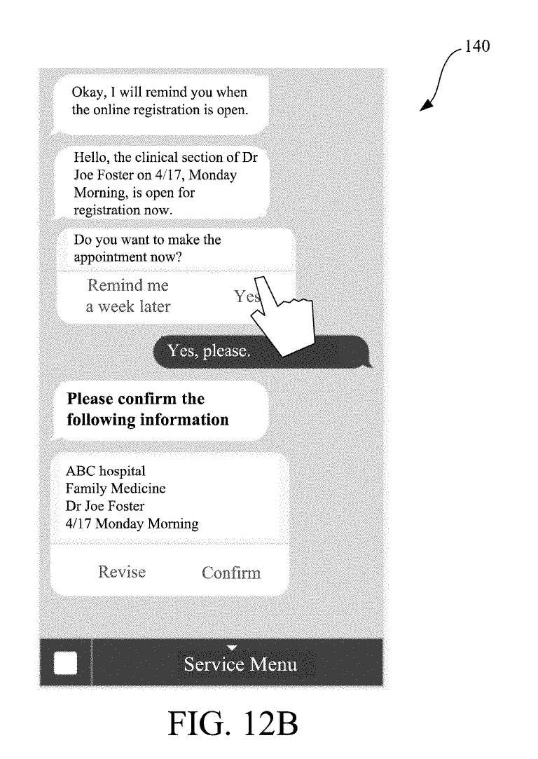

Reference is further made to FIG. 12A and FIG. 12B, which illustrate embodiments of what show on the interaction interface 140 when a clinical section which the user wants is full. Sometimes, the clinical section which the user wants may be full already. However, the user may still insist to make the appointment to the specific doctor (e.g., the doctor is famous in the specific area) at the specific time period (e.g., the user is only available in the time section). FIG. 12A shows a demonstration when the user selects a clinical section which is already full. The medical system can provide a function to remind the user to make the appointment for the same doctor at the same time section (e.g., also on Monday morning) about a clinical section which is not fully occupied in the future. If the user accept to receive the reminder, the interaction interface 140 will remind the user that the online registration (e.g., for the clinical section of Dr Joe Foster on April 17, Monday Morning) is open. The user can make his/her appointment easily through the reminder.

In another embodiment, when the user selects a clinical section which is already full, the interaction system can provide a function to remind the user to make the appointment automatically for the same doctor at the same time section (e.g., also on Monday morning) in the future. If the user accepts to make the appointment automatically, the medical system makes the appointment (e.g., the clinical section of Dr Joe Foster on April 17, Monday Morning) automatically for the user when the clinical section is open to accept the online registration.

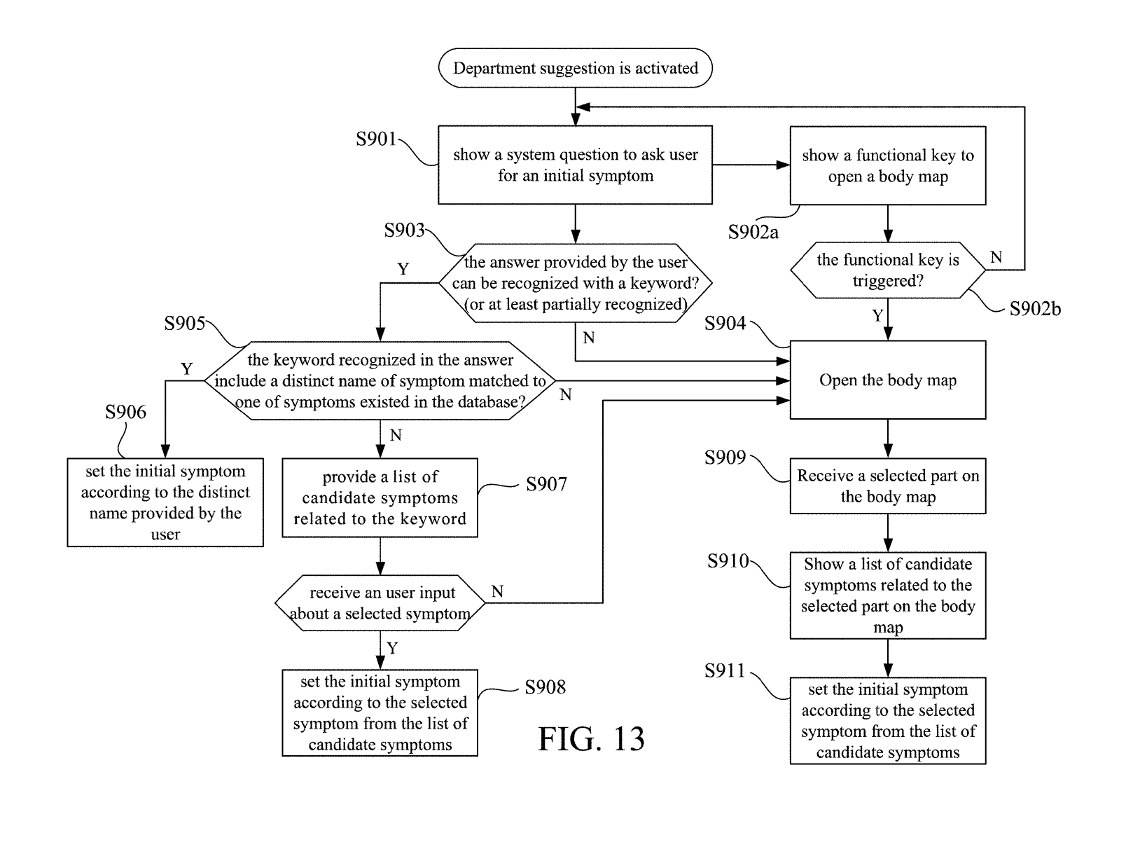

Reference is further made to FIG. 13. FIG. 13 shows a flow chart diagram illustrating how the medical system decides the initial symptom according to different types of user inputs.

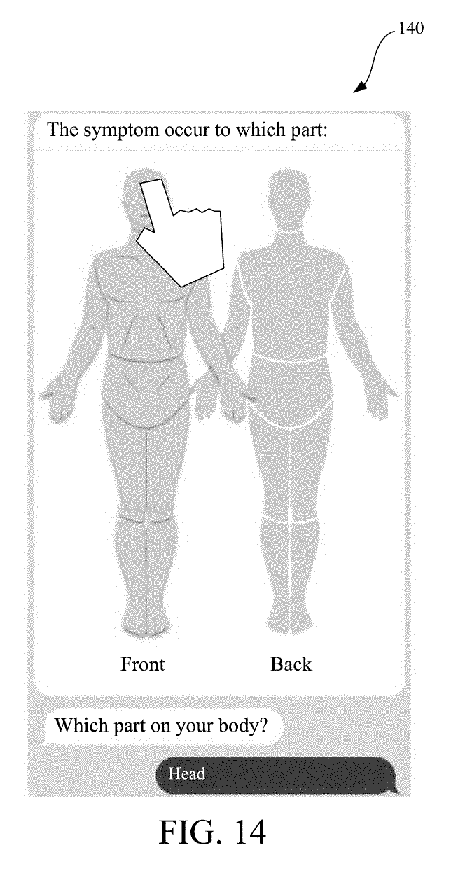

When the department suggestion is activated, the step S901 is executed, and the interaction interface 140 shows the system question to ask the user about the initial symptom. In addition, the interaction interface 140 may also provide the functional key in the step S902a to open a body map if the user doesn't know how to describe his/her feelings or conditions. Step S902b is executed to determine whether the functional key is triggered. When the functional key is triggered, the body map will be shown accordingly. Reference is further made to FIG. 14. FIG. 14 is a diagram illustrating the body map shown on the interaction interface 140 in an embodiment.

When the user provides an answer in response to the system question, the medical system will try to recognize the answer provide by the user in the step S903. If the answer cannot be recognized by the medical system (e.g., the answer does not include any keyword which can be distinguished by the interaction system), the interaction interface 140 will show the body map in the step S904, such that the user can select a region where the symptom occurs from the body map. When the answer can be recognized by the medical system, the step S905 is executed to determine whether the keyword recognized in the answer may either include a distinct name of symptom matched to one of symptoms existed in the database or without any distinct name. If the keyword in the answer includes the distinct name, the interaction system can set the initial symptom according to the distinct name in the step S906. If the keyword in the answer does not include a distinct name of a symptom, the candidate can provide a list of candidate symptom according to the keyword in the step S907. Afterward, the medical system can set the initial symptom according to the selected symptom from the list of candidate symptoms in the step S908.

On the other hand, after the body map is shown in the step S904. Step S909 is executed to receive a selected part on the body map. Step S910 is executed to show a list of candidate symptoms related to the selected part on the body map. Step S911 is executed to set the initial symptom according to the selected symptom from the list of candidate symptoms.

Based on the aforementioned embodiments, the medical system provides a way to guide to user for making an appointment, querying the medication and deciding the department to consult (and also other services). The medical system can guide the user to complete the procedures step-by-step. The user may be required to answer one question at a time or to answer some related questions step-by-step. The medical system may provide intuitive services related to medical applications.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A medical system, comprising:
an interaction interface, configured for receiving an initial symptom; and
an analysis engine, communicated with the interaction interface, the analysis engine comprises:
a prediction module, configured for generating a plurality of symptom inquiries to be displayed on the interaction interface according to a prediction model constructed by training data and the initial symptom, wherein the interaction interface is configured for receiving a plurality of responses corresponding to the symptom inquiries, and the prediction module is configured to generate a result prediction according to the prediction model, the initial symptom and the responses.

2. The medical system of claim 1, wherein the prediction module is configured to generate a first symptom inquiry according to the prediction model and the initial symptom, the first symptom inquiry is displayed on the interaction interface, and the interaction interface is configured to receive a first responses corresponding to the first symptom inquiry.

3. The medical system of claim 2, wherein the prediction module is further configured to generate a second symptom inquiry according to the prediction model, the initial symptom and the first response, the second symptom inquiry is displayed on the interaction interface, the interaction interface is configured to receive a second response corresponding to the second symptom inquiry, the prediction module is configured to generate the result prediction according to the prediction model, the initial symptom, the first response and the second response.

4. The medical system of claim 1, further comprising:
a learning module, configured for generating a prediction model according to the training data, wherein the training data comprises a known medical record, the learning module utilizes the known medical record to train the prediction model.

5. The medical system of claim 4, wherein the training data further comprises a user feedback input collected by the interaction interface, a doctor diagnosis record received from an external server or a prediction logfile generated by the prediction module, the learning module further updates the prediction model according to the user feedback input, the doctor diagnosis record or the prediction logfile.

6. The medical system of claim 1, wherein the result prediction comprises at least one of a disease prediction and a medical department suggestion matching the disease prediction, the disease prediction comprises a disease name or a list of disease names ranked by probability.

7. The medical system of claim 6, wherein the interaction interface is configured to display the result prediction, after the result prediction is displayed on the interaction interface, the interaction interface is configured to receive a user command in response to the result prediction, the medical system is configured to send a medical registration request corresponding to the user command to an external server.

8. The medical system of claim 1, wherein the prediction model comprises a first prediction model generated according to a Bayesian inference algorithm, the first prediction model comprises a probability relationship table, the probability relationship table records relative probabilities between different diseases and different symptoms.

9. The medical system of claim 1, wherein the prediction model comprises a second prediction model generated according to a decision tree algorithm, the second prediction model comprises a plurality of decision trees constructed in advance according to the training data.

10. The medical system of claim 1, wherein the prediction model comprises a third prediction model generated according to a reinforcement learning algorithm, the third prediction model is trained according to the training data to maximize a reward signal, the reward signal is increased or decreased according to a correctness of a training prediction made by the third prediction model, the correctness of the training prediction is verified according to a known medical record in the training data.

11. A method, comprising:
receiving an initial symptom;
generating a plurality of symptom inquiries according to a prediction model and the initial symptom;
receiving a plurality of responses corresponding to the symptom inquiries; and
generating a result prediction according to the prediction model, the initial symptom and the responses.

12. The method of claim 11, wherein the steps of generating the symptom inquiries and receiving the responses comprise:
generating a first symptom inquiry according to the prediction model and the initial symptom
receiving a first response corresponding to the first symptom inquiry;
generating a second symptom inquiry according to the prediction model, the initial symptom and the first response; and
receiving a second response corresponding to the second symptom inquiry.

13. The method of claim 12, wherein the step of generating the result prediction comprises:
generating the result prediction at least according to the prediction model, the initial symptom, the first response and the second response.

14. The method of claim 11, further comprising:
generating the prediction model according to training data, wherein the training data comprises a known medical record, the prediction model is trained with the known medical record.

15. The method of claim 14, wherein the training data further comprises a user feedback input, a doctor diagnosis record or a prediction logfile, the prediction model is further updated according to the user feedback input, the doctor diagnosis record or the prediction logfile.

16. The method of claim 11, wherein the result prediction comprises at least one of a disease prediction and a medical department suggestion matching the disease prediction, the disease prediction comprises a disease name or a list of disease names ranked by probability, the method further comprising:
displaying the result prediction.

17. The method of claim 16, wherein after the result prediction is displayed on the interaction interface, the method further comprising:
receiving a user command in response to the result prediction; and
sending a medical registration request corresponding to the user command to an external server.

18. The method of claim 11, wherein the prediction model comprises a first prediction model generated according to a Bayesian inference algorithm, the first prediction model comprises a probability relationship table, the probability relationship table records relative probabilities between different diseases and different symptoms.

19. The method of claim 11, wherein the prediction model comprises a second prediction model generated according to a decision tree algorithm, the second prediction model comprises a plurality of decision trees constructed in advance according to the training data.

20. The method of claim 11, wherein the prediction model comprises a third prediction model generated according to a reinforcement learning algorithm, the third prediction model is trained according to the training data to maximize a reward signal, the reward signal is increased or decreased according to a correctness of a training prediction made by the third prediction model, the correctness of the training prediction is verified according to a known medical record in the training data.

21. A non-transitory computer readable storage medium with a computer program to execute a method, wherein the method comprises:
receiving an initial symptom;
generating a first symptom inquiry according to a prediction model and the initial symptom;
receiving a first response corresponding to the first symptom inquiry;
generating a second symptom inquiry according to the prediction model, the initial symptom and the first response;
receiving a second response corresponding to the second symptom inquiry; and
generating a result prediction at least according to the prediction model, the initial symptom, the first response and the second response.
